(19) United States
(12) Patent Application Publication
(10) Pub. No.: US 2010/0271681 A1
(43) Pub. Date: Oct. 28, 2010

(54) NOVEL METHOD OF DESIGNING AND PRODUCING REFLECTORS FOR RECEIVING/TRANSMITTING ENERGY AND REFLECTORS PRODUCED BY THIS METHOD

(75) Inventor: Tomer Valach, Nesher (IL)

Correspondence Address: MARTIN D. MOYNIHAN d/b/a PRTSI, INC., P.O. BOX 16446, ARLINGTON, VA, 22215, US

(73) Assignee: Convertpower Ltd.

(21) Appl. No.: 12/745,956

(22) PCT Filed: Dec. 4, 2008
(86) PCT No.: PCT/IL08/01585

§ 371 Date: Jun. 3, 2010

(30) Foreign Application Priority Data
Dec. 4, 2007 (IL) 187890

(51) Int. Cl. G02B 26/08

(52) U.S. Cl. 359/216.1

(57) ABSTRACT

The invention is a new type of reflector, which receives energy from a source and reflects said energy onto the surface of an object. The reflector is comprised of a multiplicity of small reflecting segments attached to a substrate. The orientation of each of the reflecting segments with respect to the substrate, the source, and the object is determined on an individual basis such that the energy from the source that is reflected from the segment is directed towards a predetermined area on the surface of the object. The invention allows reflectors to be built using substrates having an arbitrarily shape. Also disclosed are methods of manually and automatically producing both single and industrial quantities of the reflector of the invention.

### FIELD OF THE INVENTION

The invention is related to the field of reflectors for receiving/transmitting energy. Specifically the invention relates to a method of designing and producing dish shaped reflectors for use as antennas for either receiving or transmitting electromagnetic radiation, as solar collectors, in optical systems, and for the transmission, and reception of sound energy.

### BACKGROUND OF THE INVENTION

One very common type of antenna used as a receiver or transmitter of electromagnetic radiation for communication purposes, etc. comprises a dish-shaped concave reflective surface, commonly called the reflector, and a small feed antenna that can either transmit or receive the radiation of the desired frequency range. The dish generally has a spherical or parabolic shaped surface and the feed antenna is located at the focus of the dish. As a result, in the case of a receiving antenna, the dish focuses the radiation that is propagated from a distant source onto the surface of the feed antenna/receiver. In the case of a transmitting antenna, the feed antenna/reflector emits radiation, which is reflected from the dish as a beam that is transmitted in the direction of a distant receiver. Dish type solar energy collectors have the same basic structure as antennas. In the case of a solar energy collector, a solar energy receiver designed to utilize the concentrated solar energy, e.g. a heat exchanger, tube filled with thermal fluid, an array of photocells, or a Sterling engine, is located at the focus of the reflective surface.

Antennas up to several meters in diameter are commonly constructed with a single reflective curved surface. A typical example of such antenna being the satellite dishes used in satellite communications systems. In the case of large antennae, the dish is made of several curved sections fitted together, or in some cases several sections of plane mirrors mounted to form an approximation of the curved surface.

One of the main problems is to match the size and shape of the focal spot of the dish reflector to those of the feed antenna or solar energy receiver. In order to solve this problem and also to construct large surface concave mirrors at reasonable cost it is well known, especially with regard to solar collectors, to make the reflecting dish as a mosaic of much smaller spherical, parabolic, or plane reflecting elements assembled on a frame or substrate to approximate a single concave surface. The main idea is laid out in U.S. Pat. No. 2,760,920 in which is described a parabolic reflector made from a “parabolic surface which is covered or floored over with small flat rectangular mirrors so that relatively cheap mirrors may be utilized to cover a large area and because of the smallness of the mirrors the individual reflections will be properly focused so that they can be received by an absorber mounted above the reflector”. Many other publications describe solar energy collection systems based on this idea. Typical of these are U.S. Pat. No. 3,713,727 and U.S. Pat. No. 4,395,581, which discuss the problem and describe solutions for matching the size and shape of the reflecting elements in order to maximize the efficiency of collection of the solar energy falling on them.

In all of the prior art antennas and solar collectors in which the reflector is composed of a mosaic of smaller reflecting elements, the smaller reflecting elements are attached to a base or frame in order to approximate as closely as possible a continuous dish-shaped concave reflective surface. As a result the energy is reflected to approximately illuminate a common target located in space on a line passing through the center of the mosaic and center of curvature of the concave surface. The size and shape of the illuminated area on the target is determined by the size and shape of the individual small reflecting surfaces that make up the mosaic. The problem being that when the small reflecting elements are attached to the substrate, the shape of the substrate determines the angle at which the incoming light is reflected towards the receiver. In practice it is very difficult if not impossible to build a perfectly shaped spherical or parabolic substrate, therefore the result is that the reflection angle from each of the reflecting elements deviates from the ideal and the energy is not concentrated at a single location but is dispersed around, in front of, and behind the focus of the reflector.

It is therefore a purpose of the present invention to provide a solution to the above problem that enables simulating the reflector surface not only such that all the energy can be concentrated at a single location on the collector, but that if desired predetermined portions of the energy can be reflected to predetermined locations on the surface of an object that is located at any location in the space between the source and the reflector, either directly above, to the side, or under the reflector.

It is another purpose of the present invention to provide a method for producing the reflectors for antennas and solar energy collectors and transmitter from a mosaic of a multitude of small plane reflecting segments attached to an arbitrarily shaped substrate.

It is another purpose of the present invention to provide a method for producing the reflectors for antennas and solar energy collectors from a mosaic of a multitude of small plane reflecting segments, wherein the energy reflected from all of the reflecting segments is not necessarily reflected towards a common location in space.

Further purposes and advantages of this invention will appear as the description proceeds.

### SUMMARY OF THE INVENTION

The invention is a reflector which receives energy from a source and reflects the energy onto the surface of an object. The reflector of the invention is comprised of a multiplicity of small reflecting segments attached to a substrate that can have an arbitrarily shape. The orientation of each of the reflecting segments with respect to the substrate, the source, and the object is determined on an individual basis such that the energy from the source that is reflected from the segment is directed towards a predetermined area on the surface of the object.

In preferred embodiments of the invention the reflecting segments are plane reflecting segments. Preferably, the maximum dimensions of each reflecting element are not larger than those of the area of the surface of the object onto which the reflecting element is expected to reflect the radiation from the source.

The reflector of the invention is suitable to be used as an antenna for either receiving or transmitting electromagnetic radiation, in a solar energy collector, in an optical system, in a radiant heater, or as an antenna for the transmission and reception of sound energy.

In an embodiment of the invention, the orientation of each reflecting segment with respect to the source, substrate, and object is individually determined in a coordinate system whose origin lies on the surface of the object at the center of the predetermined area.

The reflecting segments of the reflector of the invention can be oriented such that the energy from the source that is reflected from all of the reflecting segments falls on the same predetermined area on the surface of the object or such that the energy from the source that is reflected from the reflecting segments falls on different predetermined areas on the surface of the object.

According to the invention, the object can be positioned at any convenient location between the source and the reflector, either on top of or to the side of, the surface of reflector. One or more additional optical elements can be used direct the energy reflected from the reflector onto an object positioned beneath it.

In preferred embodiments, the substrate comprises a multitude of facets each of which comprises an upper surface having the shape and orientation of the reflecting segment at the location of the facet. In some embodiments a reflecting segment is attached to each of the upper surfaces on the facets of the substrate. In other embodiments each of the upper surfaces on the facets on the substrate has high enough reflectivity at the relevant wavelengths so that a reflecting segment is not required to be attached.

The substrate can have any two or three dimensional shape and can, for example be chosen from the following group:
(a) flat;
(b) parabolic;
(c) parabolic trough;
(d) a spherical trough;
(e) dish shaped having a non-parabolic curvature;
(f) “witch's hat”; and
(g) “sombrero”.

The substrate of a reflector of the invention can be designed and produced using a computer aided method, comprising the steps of:
a. specifying the overall parameters of the source-reflector-object system;
b. loading into a computer software that is capable of assisting a user to compute and plot distances and shapes in three-dimensions;
c. using the software and the overall parameters to create a three-dimensional image of the source-reflector-object system;
d. using the software to divide the surface of the substrate into small regions each having a size and shape equivalent to the predetermined sizes and shapes of the reflecting segment to be attached to the substrate at that location;
e. selecting one of the regions;
f. using the software to draw on the substrate a reflecting segment corresponding to the selected region;
g. using the software to tilt and rotate the drawn reflecting segment until its virtual projection falls on the surface of the object at the predetermined orientation and location with respect to the source;
h. storing in a memory of the computer data related to the three-dimensional orientation of the selected reflecting segment relative to the source and the substrate measured in a coordinate system whose origin lies at the center of the predetermined location on the surface of the object;
i. repeating steps e to h for each of the remainder of the small regions;
j. using the software to generate a three-dimensional digital map of the surface of the substrate from the stored data; and
k. using the three-dimensional map to generate instructions to manufacturing machinery that is capable of manufacturing one or large quantities of highly accurate reproductions of the substrate.

The substrate of a reflector of the invention can be designed and produced using a manual method, comprising the steps of:
a. specifying the overall parameters of the source-reflector-object system;
b. building an exact replica having a smooth surface of the over-all shape of the substrate;
c. building an exact replica of the object;
d. firmly fixing the replica of the object and a light source replicating the source at the predetermined distances and orientations with respect to the replica of the substrate;
e. selecting one reflecting element and placing it at its predetermined location on the substrate;
f. tilting and rotating the selected reflecting segment until light from the light source reflected from the segment falls on the surface of the replica of the object at the predetermined orientation and location;
g. fixing the selected segment in place on the substrate by use of an appropriate means; and
h. carrying out steps e to g for each of the remainder of the reflecting segments.

The manual method of designing and producing a substrate may comprise the additional steps of:
i. placing the substrate under a digital scanning and measuring device that generates a three dimensional digital map of the surface of the substrate; and
j. using the digital map to digitally control machinery that is capable of manufacturing large quantities of highly accurate reproductions of the substrate.

Step f of the manual method may be carried out by use of a multiplicity of mirror mounts, one for each reflecting segment, attached to the substrate; wherein each of the mirror mounts has means for independently moving the reflecting segment mounted on it transversely along and rotationally around each of three orthogonal axes.

Once the substrate has been produced the reflecting segments are attached to each of the facets. Robotic manufacturing techniques can be employed to spread a thin layer of adhesive on each of the facets and then a “pick and place” or other type of feeder robot picks up the precut reflecting segments and places it in the correct orientation on the plane surface on its respective facet.

Either the digital map itself, or a mould or a “negative” produced either from the three dimensional digital map or directly from the substrate can be used in a fully automated method suitable for mass producing additional substrates. Examples of suitable fully automated methods are extrusion of a plastic; casting molten material; forging; using the negative in a punch press or deep-drawn to stamp the desired profile into malleable material, e.g. metal, glass epoxy, plastic etc; and techniques developed in the semiconductor industry to produce substrates made from semiconductor materials.

All the above and other characteristics and advantages of the invention will be further understood through the following illustrative and non-limitative description of preferred embodiments thereof, with reference to the appended drawings.

### BRIEF DESCRIPTION OF THE DRAWINGS

FIG. 1 schematically illustrates the method of present invention;

FIGS. 2A and 2B show different views of a “witch's hat” shaped reflector substrate;

FIG. 3 shows a “sombrero” shaped reflector substrate;

FIG. 4 shows a solar heat collector comprised of a sombrero shaped reflector and a ring shaped object;

FIG. 5A and FIG. 5B show respectively perspective bottom and top views of a solar heat collector comprised of a sombrero shaped primary reflector, a ring shaped secondary reflector, and a ring shaped object;

FIGS. 6A and 6B show different views of a parabolic shaped reflector substrate; and

FIG. 7 to FIG. 9 are photographs of a laboratory model reflector of the invention that has been built and tested; and

FIG. 10 is a bar graph that summarizes field trials carried out to measure the power output of the laboratory model reflector.

### DETAILED DESCRIPTION OF PREFERRED EMBODIMENTS

For simplicity the description hereinbelow refers mainly to solar energy collectors. However it is to be understood that the system comprising source, reflector, and object is bi-directional; therefore, the invention can be applied equally well mutatis mutandis to designing and producing electromagnetic antennas, e.g. receivers and transmitters for communication systems and reflectors for electric radiation heaters; to solar energy collectors and to optical systems, e.g. telescopes. Additionally it is felt by the inventor that the method of the invention can be used to design and create improved devices for receiving and transmitting sound.

Therefore the term “reflector” is used herein to refer to the surface made up of a multiplicity of small reflecting elements. The purpose of the reflector is to either receive energy from a source at a distant location and reflect it in the direction of and concentrate the energy on the surface of an object, which is typically but not necessarily located near to the reflector or, reversibly, to receive energy from a nearby source and reflect it in the direction of an object at a distant location. The term “object” is used herein to refer to a device upon which the energy from the source is directed by the reflector. The meanings of the terms “multiplicity” and “small” as used herein can not be easily quantified and in practice are defined during the design stage of a reflector for a particular application. In general the maximum size of a reflecting element can not be larger than the area of the portion of the surface of the object onto which the reflecting element is expected to direct the incoming radiation in order to prevent loss of energy and maximize the efficiency of the energy collection and is typically much smaller, especially in the case of reflectors having relatively complex surface shapes. If the reflecting elements have curved surfaces then they need not be smaller than the area on the object onto which they reflect the energy since their curvature can be designed to focus the energy. In any case, even the smallest and most symmetrically shaped reflectors will be comprised of tens of reflecting segments and for larger or more complex reflectors the number will typically be hundreds or even thousands or more.

In the prior art the object is supported above reflector with its center at a distance equal to the focal length of a spherical or parabolic shaped reflector. Assuming a perfectly spherical or parabolic shaped substrate and that the dimensions of each of the plane mirror segments are small compared to the total surface area of reflector, then by simply gluing the segments to the parabolic substrate, the optical axis of each segment will point towards the center of object causing the energy reflected from each of segments to overlap on the face of object. For plane mirror segments, the dimensions of the segments are made approximately equal to those of the face of object and therefore, at least in theory, all of the energy that is incident on the reflector is concentrated onto the face of object. The problems are: it is difficult to produce a perfectly shaped substrate/frame; if the plane reflector segments are larger than the surface area of the collector at the focus of the reflector, then energy is wasted; and, if the plane reflector segments are made too small, which would increase the accuracy of their overlap, than the entire surface of the object will not be “illuminated” by the light reflected from the segments. In addition, since the “illuminated” area of the object has the dimensions and shape of the plane reflector segments, energy is often wasted as a result of differences in geometry between the shape of the segments and the object.

The root cause of the above described problems that occur in the prior art is that the orientation of each of the mirror segments relative to the source and object is dependent on the shape of the surface of the substrate at the location of that segment. The method of the present invention overcomes the problems of the prior art by breaking this dependence.

As said, the main goal of the present invention is to solve the problem resulting from attaching the segments directly to the surface of the substrate. This is done by adjusting each segment on the substrate individually with reference to the object according to a predetermined angle that will bring the energy from the source and reflected from that segment to a predetermined location on the surface of the object, which can be located at any location in the space between the source and said reflector.

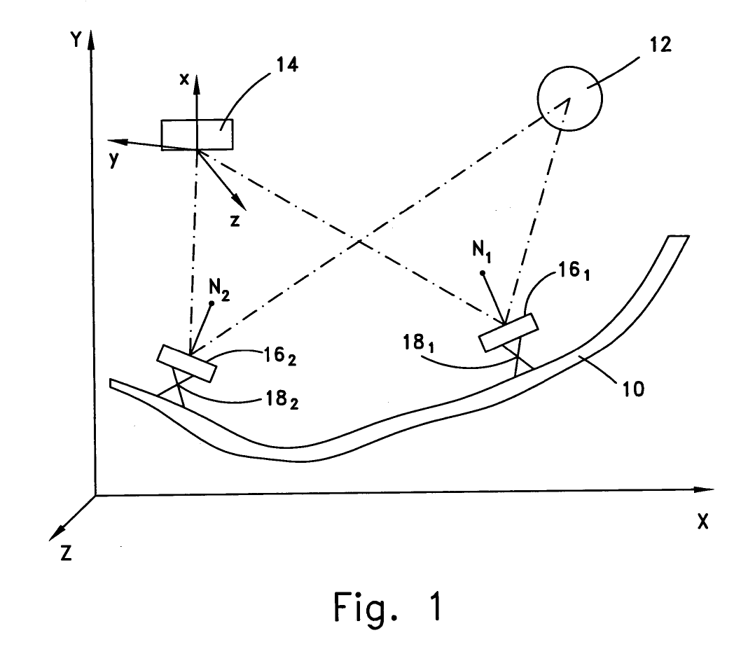

FIG. 1 schematically illustrates the method of the present invention. A solar energy collector comprising a reflector made up of a multiplicity of small reflecting segments 16ᵢ (only two of the segments 16₁ and 16₂ are shown in FIG. 1) that is attached by suitable attachment means 18ᵢ to an arbitrarily shaped substrate 10 is shown in FIG. 1. The purpose of the reflector is to concentrate the radiation from sun 12 that falls on the reflector onto the surface of collector 14, which might be, for example, a solar cell, part of a tube containing a thermal fluid to be heated by the solar radiation, the high temperature side of a Sterling engine, etc.

Cartesian coordinate system (X,Y,Z) is a “universal” coordinate system with the location of its origin and its orientation conveniently determined so as to describe the relative locations and distances between the centers of the source 12, the location on the surface of object 14 on which the energy is to be concentrated, and the centers of each of the reflecting segments 16ᵢ.

According to the invention, the orientation of each reflector segment 16ᵢ with respect to substrate 10 is determined on an individual basis. There are many ways of planning the correct orientation for each segment on the surface of the substrate. One way of visualizing the calculations that must be carried out to accomplish this task (either manually and/or with the help of computer programs) is presented herein below with reference to a coordinate system (x,y,z) whose origin is located at the center of the area on the surface of object 14 on which the radiation from segment 16ᵢ is intended to fall. This coordinate system is totally independent from the geometry of the substrate. Following the basic principles outlined herein, persons skilled in the art will be able to devise an efficient method suitable to their needs for planning a reflector according to the present invention.

An example that illustrates the principles of the method of orientating each of the reflecting segments on the substrate 10 relative to the source and object will now be described with reference to FIG. 1. Consider first segment 16₁. A coordinate system (x,y,z) is drawn on the object 14 with its origin at the predetermined center (located in coordinate system X,Y,Z) of the area on the surface of object 14 on which the solar energy reflected from segment 16₁ is to fall. Coordinate system (x,y,z) is oriented such that the x,y plane is tangent to the surface of object 14 at the origin (x=y=z=0) and the z axis points in the direction of substrate 10.

Two virtual lines are now drawn from the center of the predetermined location of segment 16₁ on the substrate. The first is drawn to the origin (x=y=z=0) and the second to the center of the source 12 respectively. Finally a normal Nᵢ is drawn at the center of 16₁ and the planar segment is rotated and tilted relative to substrate 10 until N₁ bisects the angle between the two previously drawn lines. Finally the footprint of the reflected beam on the surface of the object is oriented to match the shape of the object's surface by rotating the segment around the virtual line between the origin and center of the segment, without changing its tilt with respect to the substrate or neighbor segments. The segment 16₁ is now fixedly attached to substrate 10 by means of attachment means 18. It should be noted that instead of using plane reflecting segments and using the attachment means to attach them to the substrate at the correct orientation, it is possible to make the reflecting segments from triangular prisms having a plane reflecting surface facing the direction of the incident and reflected radiation and a triangular cross-section having different angles.

A new pair of virtual lines is now drawn connecting the origin (x=y=z=0) and the center of the source 12 respectively to the center of the predetermined location of segment 16₂ on the substrate. and the same steps are repeated for segment 16₂ and then for each of the remaining segments.

For maximum concentration of the energy on a small area of the object, the same coordinate system (x,y,z) is used to orient all of the segments. If each of the segments is tilted and rotated as described herein above, then the reflected beams from all of the reflecting segments will fall one on top of each other, thereby resulting in a “focused image” whose surface area is essentially equal to the size and shape of the largest of the reflecting segments 16ᵢ.

In the case in which it is desired to have the energy fall on an area of an object 14 that is larger than the size of the segments or in other circumstances, for example if it is desired not to concentrate the energy at a single spot or if it is desired to distribute the energy either evenly or unevenly on all or part of the surface of the object, then more than one coordinate system is drawn on the surface of object 14. The origin of each of the coordinate systems (xⱼ,yⱼ,zᵢ) is located at the center of the area of the surface of object 14 on which the beam reflected from specific reflecting segments 16ᵢ are designed to fall. For example, referring to FIG. 1, if the segments 16₁ and 16₂ are squares two cm long on each side and the object 14 is a rectangle two cm high and four cm long, then, if uniform illumination of the object is desired, half of the segments are oriented with respect to a coordinate system with its origin located at the center of the left half of the rectangular target and the other half of the segments are oriented with respect to a coordinate system with its origin located at the center of the right half of the target. If non-uniform illumination of the reflector's surface is desired, then the ratio of the number of reflecting segments oriented towards each portion of the object is adjusted accordingly. These same principles can be used to illuminate the surface of an object having any size of shape or with any illumination pattern.

As a result of the changes from the traditional approach that are described herein above, the shape of the substrate is no longer important and an arbitrarily shaped substrate can be used. One consequence of the present invention is that new shapes of reflectors different from the traditional spherical and parabolic designs can be built. Also, since each individual reflector segment can be given any arbitrary orientation, not all segments have to be aimed at the same location in space, i.e. at the focus of the reflector. This allows the object 14 to be positioned at any convenient location above, either on top of or to the side of, the surface of reflector and also allows the possibility of using objects having many different shapes. With the use of additional optical elements, e.g. one or more reflecting surfaces, the energy can be directed so that the object 14 can also be positioned beneath the reflector, i.e. the object may be further from the source than the reflector.

According to the method of the invention the substrate of the reflector can be designed either automatically by employing a suitable computer program and/or manually. In the first step the overall parameters of the reflector-object system must be specified. These parameters include, but may not be limited to: the overall shape and dimensions of the reflector; the shape and dimensions of the plane reflecting segments; determining whether all of the segments will have the same shape and dimensions and/or if the value of these parameters for an individual segment will depend on its location on the surface of the reflector; the shape and dimensions of the feed antenna/solar energy object; and, the relative locations in space of the source, the reflector and the object. All measurements of distance and orientation of the segments with respect to the object and source are made with respect to a coordinate system whose origin is located on the part of the surface of the object on which the energy reflected or transmitted from the segment is required to fall. If this part of the surface is symmetric, then the origin of the coordinate system is typically, but not necessarily, located at its center. The invention maximizes the efficiency of energy transfer from the reflector, which is made up of a multiplicity of small plane reflecting segments that are attached to a substrate or frame such that the reflecting surface of each segment is not necessarily parallel to the surface of the substrate/frame at the location of the segment.

There follows a specific, but not limiting example to illustrate a computer aided method for designing the substrate of the reflector of the invention. Using a computer program capable of computing and plotting in three-dimensions, e.g. SolidWorks, OptisWorks, etc., a three dimensional drawing showing the substrate and the object, taking into account the predetermined shapes, dimensions, distance between, and relative orientation of the two surfaces and the relative distances between and locations of the centers of the source, substrate, and object is drawn and stored in the computer memory. There are many ways of planning the correct orientation for each segment on the surface of the substrate for example; the surface of the substrate is divided into small regions each having a size and shape equivalent to the predetermined sizes and shapes of the reflecting segment to be attached to the substrate at that location. As described with relation to FIG. 1, a three dimensional coordinate system (x,y,z) having its origin located at the geometrical center of the portion of the surface of the object on which the energy reflected from the reflector is required to fall is drawn. A single region is now selected and two virtual lines are now drawn from the center of the segment to the origin of (x,y,z) and to the center of the source respectively. A plane segment is drawn tangent to the surface of the substrate at the region and a normal to the plane reflecting surface is drawn at the center of the segment. The programmer now tilts the segment with respect to the surface of the substrate source and object until the normal bisects the angle between the two virtual lives. When this condition is met the center of the beam reflected from the reflecting segment will fall on top of the center of the area on the surface of the object on which it is meant to fall. The footprint of the reflected beam on the surface of the object can now be oriented to match the shape of the object's surface by rotating the segment around the normal to its surface without changing its tilt with respect to the substrate and/or neighbor segments.

Data concerning the location of the center of the segment, the orientation of the normal, and the rotation angle are stored in the computer memory and then the process is repeated for each of the reflecting segments. The process can either be carried out for one segment at a time or for groups of segments by taking advantage of symmetry and/or applying data processing techniques that are well known for speeding up such an iterative process.

The data concerning the location of the center of each of the segments, the orientation of the normal to its surface, and its rotation angle that have been stored in the computer memory are now used to generate a three dimensional digital map of the surface of the substrate. The digital map in turn is used to generate instructions to manufacturing machinery that is capable of manufacturing a substrate, which will have its upper surface covered by a plurality of facets each having a small planar surface which is correctly oriented in space with respect to a specific area of the object and will serve as a “seat” for the respective reflecting element that will be added at a later stage of the manufacturing process of the reflector.

It is to be noted that for some configurations of reflector or object, e.g. a ring object as described hereinbelow, other types of coordinate system, e.g. cylindrical or spherical, might be more appropriate than the Cartesian coordinate system used in the example herein above.

Instead of using coordinate systems as described in the example herein above, a computerized technique can be employed in which the system is described in terms of a three-dimensional matrix in which are located all elements of the solar energy collector system—the source, the reflector/substrate, the object, and the multitude of plane reflecting segments—in relation to some pre-determined coordinate system. The orientations of the individual reflecting surfaces can than be calculated by the use of offset pointers that travel to the appropriate locations in the three-dimensional matrix.

Many other methods of defining the relative locations and orientations of the various elements of the solar energy collector are known in the art or can be devised by skilled persons. The invention is not meant to be limited to any specific manner of carrying out the calculations for designing the collector, but is more generally defined in terms of the relationship between each reflecting segment and the object and the source.

A manual process of producing the substrate can also be used. In this case, an exact replica having a smooth surface of the over-all shape of the substrate of the reflector is built. A reproduction of the object is constructed and it and a light source, e.g. a laser or extended source producing a beam representing the distant source are firmly fixed by use of a suitable frame at the predetermined orientations with respect to the substrate. Now one of the reflecting elements is taken and manually placed at a predetermined location on the surface of the substrate and tilted and rotated the segment until the footprint of the reflected beam falls, with the desired orientation, on the predetermined location on the object. Once the correct orientation of the segment is determined it is fixed in place by use of an appropriate means, e.g. glue, plaster of Paris, molding clay. The procedure is then carried out one at a time for each of the remaining segments.

The substrates can be manufactured individually by following the above procedures, but for mass production, it is preferred to place the prototype substrate under a digital scanning and measuring device that generates a three dimensional digital plan or 3D “map” of the surface of the substrate. The map can then used to digitally control any fully automated method suitable for mass producing the substrates, for example to control machinery that will manufacture large quantities of relatively inexpensive but highly accurate reflector substrates. Alternatively, a mould or a “negative”, can be produced either from the three dimensional digital map or directly from the prototype substrate. The mould can than be used in a process such as extrusion of a plastic. The negative can be used in a punch press or deep-drawn to stamp the desired profile into malleable material such as metal, glass epoxy, plastic, etc. Other possible methods of mass producing the substrate could be forging or using techniques developed in the semiconductor industry to produce substrates made from semiconductor materials.

To create a test set-up that can be used to plan, test, and produce substrates for reflectors for a variety of designs or other applications, a multiplicity of planar reflecting segments are each mounted individually on a separate mirror mount that can be independently moved transversely along and rotated around three orthogonal axes. In this way the manual alignment can be quickly carried out for each segment and it can be locked in position before adjusting the next segment. When all of the segments have been aligned, the resulting substrate can be scanned as described above to create an electronic map of the reflector surface.

In preferred embodiments the substrate comprises a multitude of facets each of which comprises an upper surface having the shape and orientation of the reflecting segment that will be placed at the location of the facet to direct the radiation to the predetermined location on the object. Once the substrate has been produced the reflecting segments can be attached to each of the upper surfaces on the facets. Preferably robotic manufacturing techniques are employed to spread a thin layer of adhesive on each of the plane surfaces and then a feeder robot, e.g. a “pick and place” robot picks up each of the precut reflecting segments and places them in the correct orientation on the plane surface on the respective facet.

Many different suitable methods of producing the reflectors once the prototype substrate has been produced, either manually and/or digitally, are either known or can be devised from available knowledge in the art and therefore they will not be described herein in further detail. In this regard it is noted that the inventor envisages the use of MEMS technology in accordance with the method of the invention to manufacture reflectors that will enable very high concentration and accurate placement of the radiation on the surface of the collector/feed antenna for solar collectors and receiving/transmitting antenna amongst other applications.

The reflector substrates can be produced from any suitable material, e.g. glass, polymer, metal, silicon, etc. which will remain stable and not deform under the influence of the mechanical and environmental stresses that will be exerted on it.

The shape of the reflecting segments is determined for each application and depends, amongst other factors, on the shape of the portion of the surface area of the object/feed antenna upon which the energy reflected from each segment is to fall and the angles from the source of the radiation to the segment and from the segment to the object.

The material of which the plane reflecting segments are made depends on a number of factors including the wavelength of the radiation, the energy density, the desired quality of the results, and cost. The reflecting segments can either be made of a substrate material having one planar surface treated so that it is able to reflect most of the energy of the relevant wavelengths, for example highly polished metal, or may consist of a substrate that is coated with a thin reflecting layer, for example a glass plate coated with a metal such as aluminum, nickel, gold, etc.

For some applications it might not be necessary to add additional reflecting surfaces if the substrate is made of a material whose reflectance in the relevant wavelength band is high enough. For example, for home dish antennas for satellite television reception the substrate can be made of metal, which has a high enough reflectivity at the relevant wavelengths to allow the upper surfaces of the facets on the substrate to function as the reflecting segments. For other applications the entire substrate, including the plane surfaces of the facets can be coated by a thin layer reflecting coating, thereby eliminating the need for individually attaching reflecting segments to the facets.

For a solar energy collector the most common choices for reflecting segments are glass plates covered with an appropriate metallic thin film coating or fine surfaced plates made from e.g. metal, alloy, composite material, carbons, aluminum carbon, carbon fiber, ceramic, glass epoxy, crystals, polymer and coated with any suitable stable coating material, which can be either uncoated or coated with a reflecting layer. Coated glass, plastic, or polymer plates are preferred because they can be easily and consistently produced having very flat parallel sides and high quality reflecting surfaces. On the other hand, when polishing metal plates it is difficult to maintain the parallelism of the surfaces and to achieve uniformity in the quality of the polishing over the entire surface of the reflecting segment. As a result when attached to the facets on the substrate the polished metal plates might not reflect the incoming beam exactly to the planned location on the surface of the object. In addition, it is much less expensive to produce and coat glass or plastic blanks than to produce and polish metal ones.

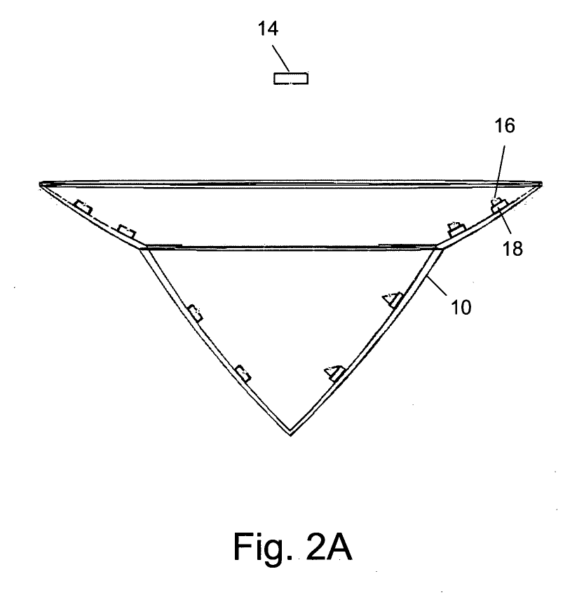

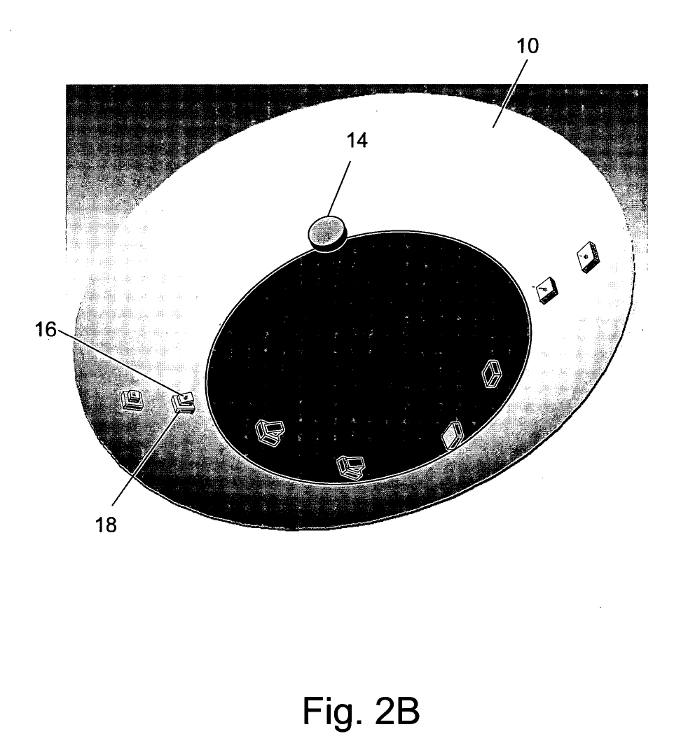

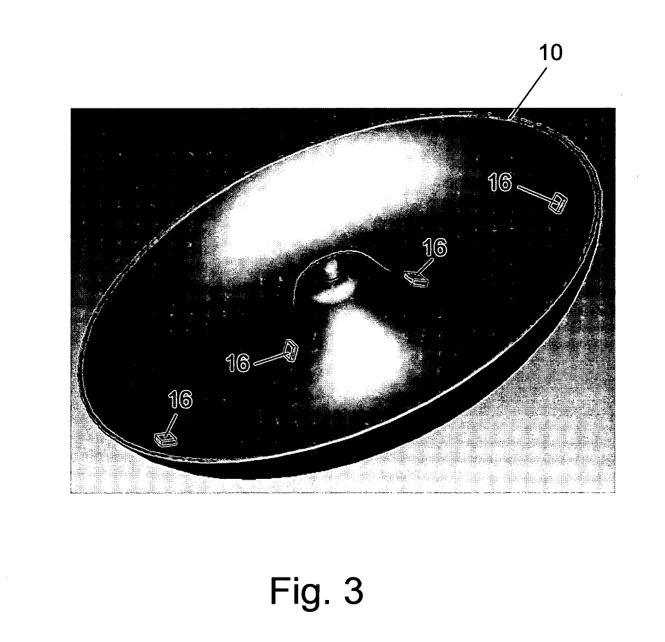

Using the method of the invention to make the reflector from a multitude of small plane reflecting segments each of which is individually aimed to reflect incident electromagnetic energy in a predetermined direction instead of the methods of the prior art reflectors, which largely comprise concave reflectors with the solar energy collector/feed antenna located at the focus of the reflector, allows for great flexibility in design of both the reflector and the collector/feed antenna. The method of the invention allows use of a reflector comprising a substrate having any arbitrary two or three dimensional shape, e.g. a flat substrate; a traditional parabolic dish substrate; a spherical or parabolic trough; a dish shaped substrate having a non-parabolic curvature; or non-conventional shapes that are impossible to use according to the prior art, e.g. the “witch's hat” shaped substrate shown in a cross-sectional view in FIG. 2A and in a perspective view in FIG. 2B or the “sombrero” shaped substrate shown in FIG. 3. Note that all of the figures are schematic and the dimensions and distances are not drawn to scale. Only a representative few of the multiplicity of small reflecting segments 16 are shown in the figures for clarity. Although not clear from the figures, each of the reflecting segments 16 is mounted on substrate 10 by means of attachment means 18 at an orientation with the surface of the substrate that is individually determined for each segment, wherein the angle depends on the relative locations of the source (not shown), object 14, and specific segment as described herein above. It is obvious from these figures that if plane reflecting segments were attached directly to the substrate, reproducing its shape as in the prior art, most of the energy from the source would not be reflected onto the object.

Proper design of the contours of the interior of a reflector such as that shown in FIG. 3 combined with accurate placement of the reflecting segments in terraces ascending the slopes of the central bell-shaped feature results in an effective increase of the area of the energy gathering area over that of a parabolic antenna having the same maximum diameter. In particular, by adjusting the angles of the slopes, not only the direct (parallel) energy incident on the reflector is utilized, but also energy from the “sides” can also be redirected to fall on the collector, thereby significantly increasing the amount of energy that falls on the surface of the object.

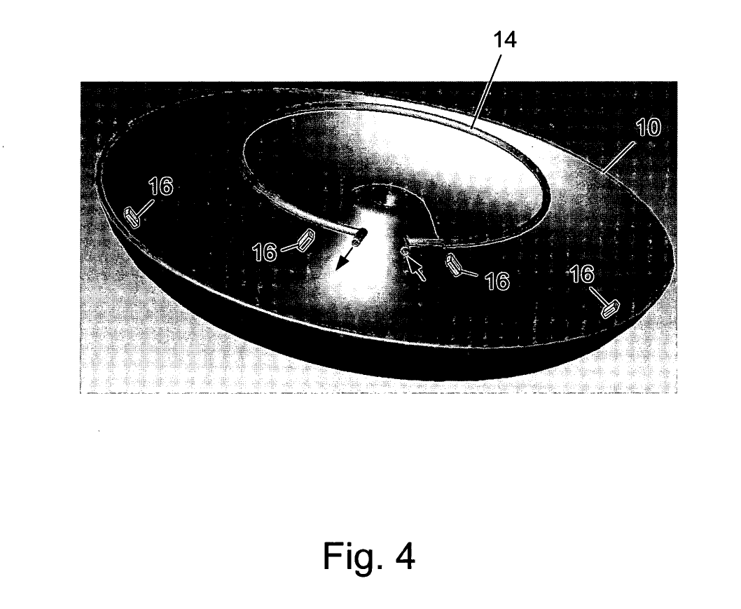

One advantage of the non-conventional reflector shapes such as those shown in FIGS. 2 and 3 is that they allow more possibilities for easily aiming different reflecting segments towards different directions to utilize different shaped collectors. As an example to illustrate this point, FIG. 4 shows a reflector and collector arrangement comprised of a sombrero shaped reflector 10 and a ring shaped object 14. This configuration is very suitable for a solar heat collector in which case the object is a blackened section of hollow tube bent in the shape of a circle and connected in series to a closed circuit through which a thermal fluid is circulated. The thermal fluid in the object is heated by the sunlight reflected onto it by the reflecting segments of the reflector, thereby converting the solar energy to heat energy. The heated thermal fluid flows to another part of the system (not shown) in the figures where the thermal energy is e.g. converted to mechanical or electrical energy, thereby cooling the thermal fluid, which flows back to the object where it is again heated. As described above, by adjusting the angles of the slopes, not only the direct (parallel) energy incident on the reflector is utilized, but also energy from the “sides” can also be redirected to fall on the object.

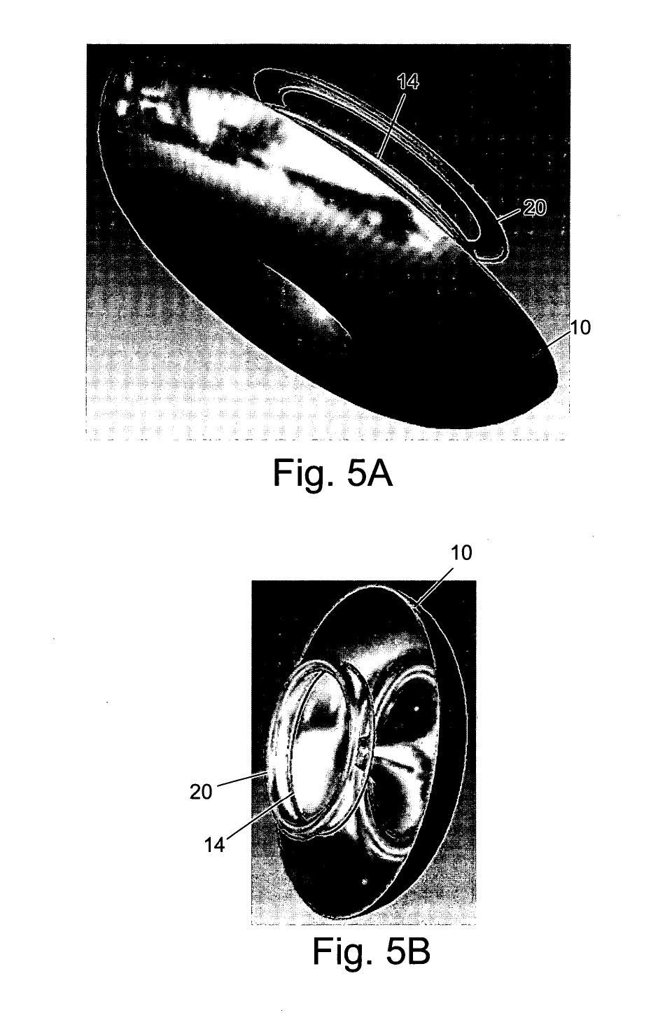

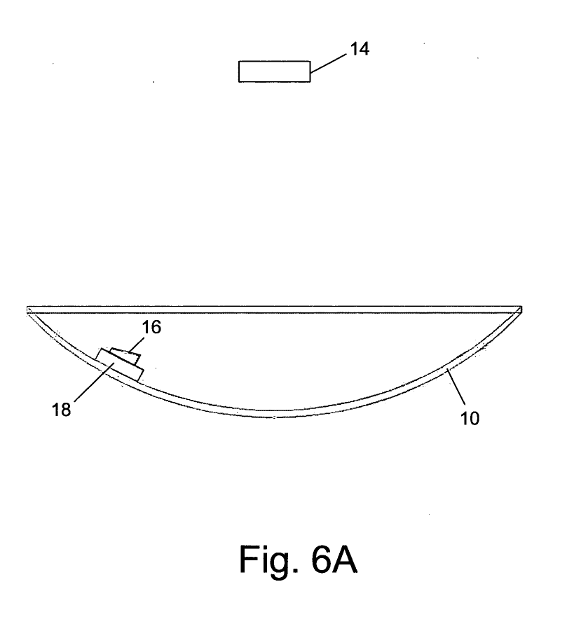

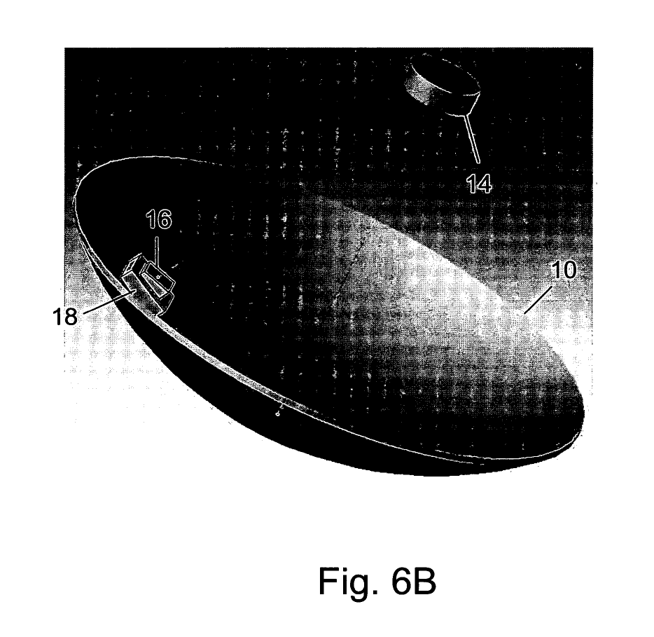

The method of the invention also allows more complicated systems to be devised to further concentrate or redirect the incoming/outgoing radiation. For example FIG. 5A and FIG. 5B show respectively perspective bottom and top views of a solar heat collector comprised of a sombrero shaped primary reflector 10, a ring shaped secondary reflector 20, and a ring shaped object 14. In this case, the reflecting segments (not shown) are oriented to completely illuminate the concave surface of the circular upper secondary reflector. The secondary reflector can have a single smooth surface or, preferably is comprised of a multitude of small planar reflecting segments according to the present invention. In the latter case, the method of the invention is again applied to orient the individual reflecting segments of the secondary reflecting surface to accurately illuminate the ring shaped collector located between the primary and secondary reflectors.

Typical solar energy converter systems that could very advantageously utilize the non-conventional reflectors and objects made possible by the present invention are described in co-pending International Patent Application WO2008/107875 by the same applicant, the description of which, including publications referenced therein, is incorporated herein by reference.

It is noted that the description herein assumes a fixed relationship in space between the centers of the source, reflector, and area of the object on which the energy from the source is to be reflected. If these conditions are not met, then skilled persons will be able to either create or adapt existing physical solutions or computational techniques to achieve the desired results. For example, in a solar collector a solar tracking system, i.e. a heliostat, can be used to rotate the substrate and collector and change their elevation such that the relative positions of sun, reflecting segments, and object remains constant throughout the day.

Skilled persons will also recognize that, because each segment is individually oriented to reflect the energy from the source onto a specific location on the object, many possibilities of directing the energy are now available using a single reflector. In one embodiment the reflector acts as an energy mixer by directing energy from two or more different sources to the same area of an object. This is done by reflecting the energy from each of the sources from different groups of the segments comprising the reflector. The ratio of energy from each source that will be directed to a particular location on the object is controlled by the ratio of the numbers of segments in each group. In another embodiment the reflector acts as a beam splitter by directing energy from one source to more than one object. In a similar manner the reflector of the invention can be used in many different configurations to direct light from one or more sources to one or more objects.

It is noted that the basic design of the “sombrero” shaped reflector, even when not comprised of a multiplicity of small reflecting surfaces as required by the present invention, will reflect or receive more energy than conventional reflectors having the same diameter because of the additional surface area that results from using the slope of the central bell-shaped feature. Thus a sombrero shaped reflector made from uncoated material suitable for the type of energy being reflected or transmitted, can be a very effective reflector or receiver of electromagnetic energy; coating the surface with a reflecting material can improve the performance making a sombrero-shaped substrate into a very efficient reflector of electromagnetic energy. In other applications, a sombrero shaped substrate coated with energy absorbing material can be used to efficiently absorb energy, e.g. heat from solar radiation that can be used to heat water or thermal oil.

### Laboratory Model

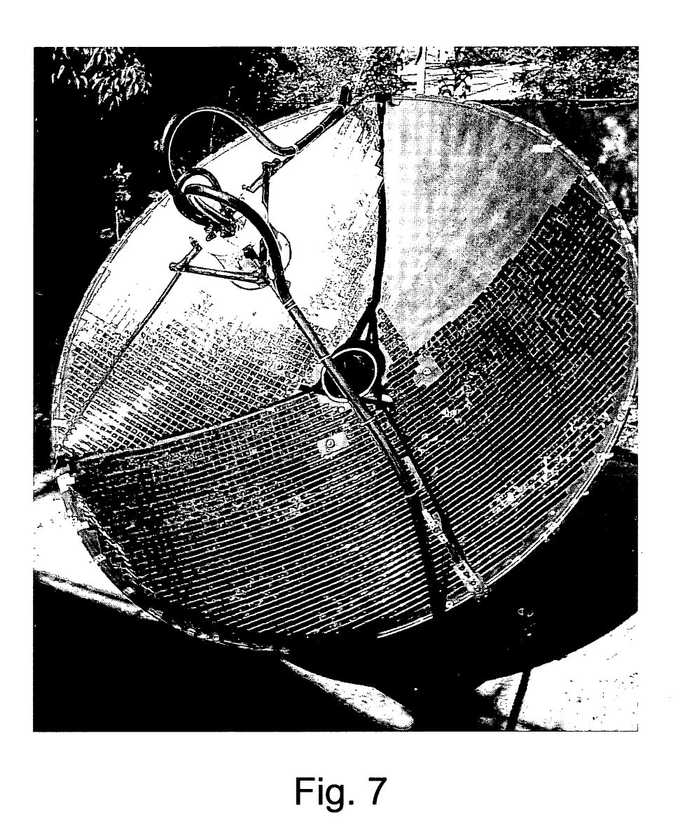

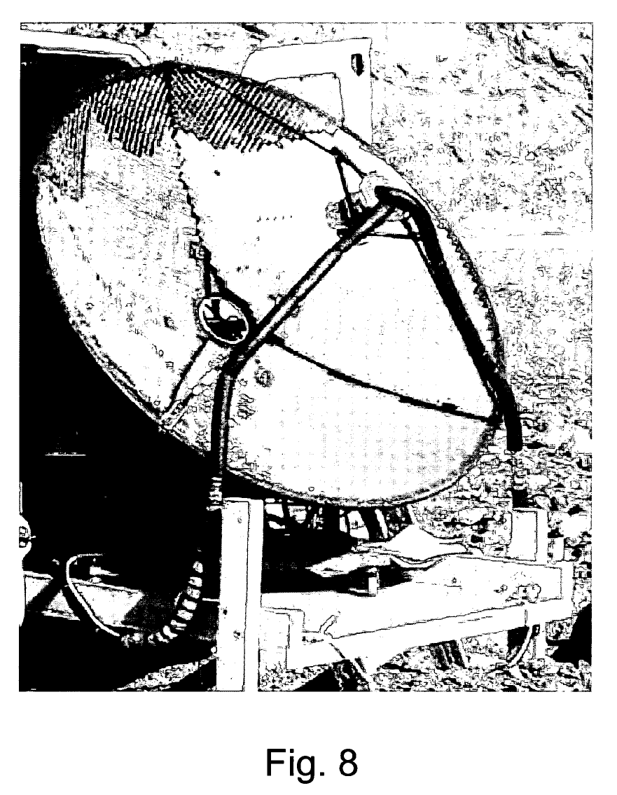

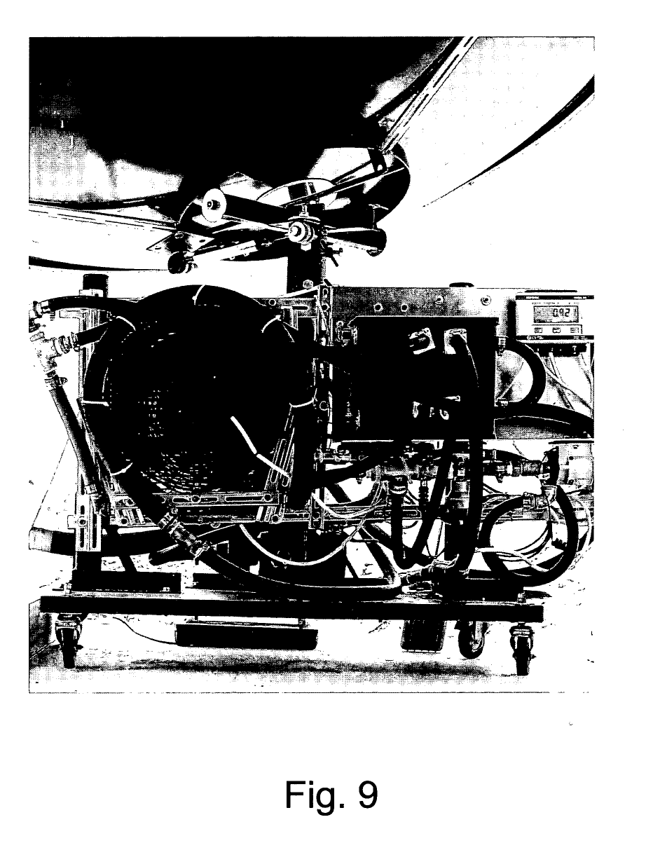

FIG. 7, FIG. 8, and FIG. 9 are photographs of a laboratory model reflector that has been built according to the manual method described hereinabove and tested in the field. The laboratory model was built by attaching, one at a time, 4,800 2 cm×2 cm plane mirror segments having a thickness of 2 mm to a substrate. The substrate used to build the model is a conventional concave dish used to receive satellite television signals. The substrate is made of metal having a thickness of 0.6 mm and a diameter of 1.6 m. The effective area of the reflector is 1.84 m².

The substrate is mounted on a pipe by means of joints that allow it to be manually tilted to aim the central axis of the substrate at the sun. A heat collector was built and supported above the substrate and on its central axis by three arms (see FIG. 7). A system of pipes allows cold water to flow through the collector. Water enters the collector, is heated by the solar energy concentrated upon the collector by the reflector, and exits the collector. The amount of energy produced can be determined from the difference in temperature at the input and output sides of the collector and the flow rate.

Behind the reflector is a system to circulate and cool the water and to determine the energy produced by the reflector. The energy determination is carried out by use of sensors to measure the temperature at the inlet and outlet of the collector and the flow rate that are operatively connected to a Contrec 212 Heat Calculator. The entire system including reflector, collector, water circulation and cooling system, and the Heat Calculator, is built as an integrated, compact unit and mounted on wheels to allow it to be easily moved (see FIG. 9).

To attach the mirrors, the unit was wheeled outdoors and the substrate was oriented such that its central axis was aimed directly at the sun. Each segment was attached to the substrate with an adhesive and its orientation adjusted with the aid of tweezers before the adhesive had time to set such that the sunlight reflected from the segment fell on the center of the collector. FIG. 7 shows the reflector with about 80% of the reflecting segments attached. FIG. 8 shows the finished reflector set up in the field for the field trials.

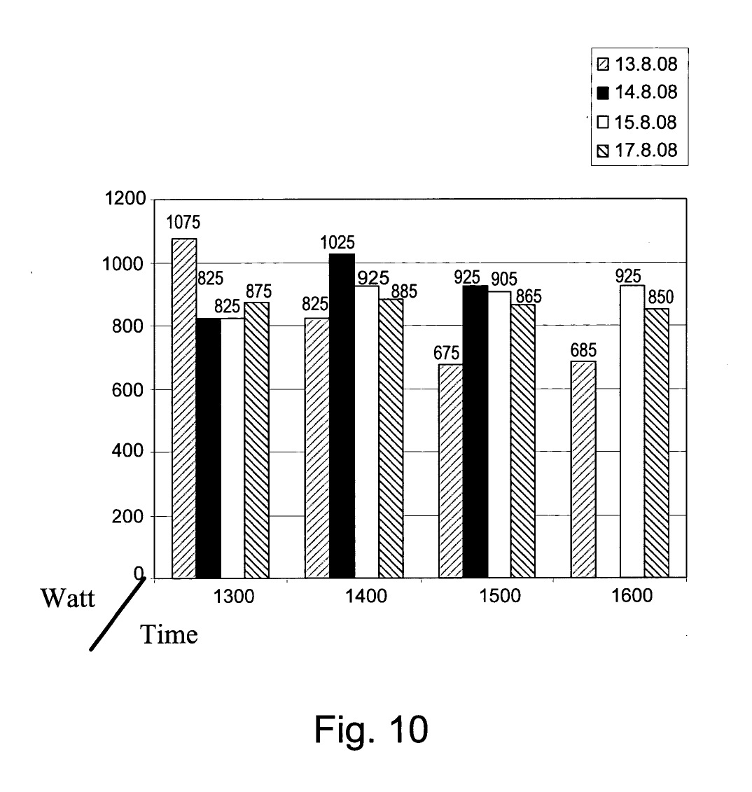

In order to test the efficiency of the reflector, the entire unit was loaded onto a small commercial van and taken to a desert area outside of Eilat, Israel. The trial took place under cloudless skies on four days in mid August, 2008. Each day, between the hours of 13:00 and 17:00, the unit was wheeled out of the van, pointed at the sun, and measurements of the power generated by the system were made. Some of the results of the field trials are displayed in FIG. 10. FIG. 10 is a bar graph with the time of day at which the measurement were taken displayed on the horizontal axis and the maximum power output of the laboratory model reflector, measured in watts, displayed on the vertical axis.

In order to determine the efficiency of the laboratory model, the measurements were compared with theoretical calculations based on information supplied by the Israeli Meteorological Service, which maintains a data collection station very close to the location at which the field trials were carried out. At the meteorological station measurements of the solar radiation are recorded every ten minutes. On Aug. 13, 2008 the solar radiation at ground level was 721 w/m² at 15:40 and 688 w/m² at 15:50. For a reflector having an area of 1.84 m² the solar radiation falling on the reflector at 15:45 is calculated to be 1.84*704.5=1296 watts. At the same time the measured power output of the reflector was 1075 watts (after decreasing the actual measured output by 75 watts to account for measurement error). Based on these figures, the efficiency of the hand-made laboratory model is calculated to be 1075/1296=82%.

Although embodiments of the invention have been described by way of illustration, it will be understood that the invention may be carried out with many variations, modifications, and adaptations, without exceeding the scope of the claims.

1-25. (canceled)

26. A reflector for receiving energy from a source and reflecting said energy onto a surface of one or more objects, said reflector comprising:
a multiplicity of planar reflecting segments attached to a substrate, wherein:
a. said planar reflecting segments are fixedly realized on a substrate;
b. said substrate comprises an upper surface covered by a multiplicity of facets, each facet having an upper planar surface;
c. said reflecting segments are realized on said upper planar surfaces of said facets by one of the following:
i. the natural reflection of said upper planar surfaces of said facets, which is such that said surfaces reflect most of the energy of relevant wavelengths;
ii. treating said upper planar surfaces of said facets such that said surfaces reflect most of the energy of relevant wavelengths; or
iii. permanently attaching a plane minor segment to said upper planar surface of each of said facets such that the reflecting surface of said plane minor segment is parallel to said upper planar surface; and
d. the orientation of each of said upper planar surfaces of said facets with respect to said substrate, said source, and said object is determined on an individual basis such that the energy from said source that is reflected from respective reflecting segments realized on each of said facets is directed towards a predetermined area on the surface of at least one of said objects.

27. A reflector according to claim 26, wherein, the orientation of each facet with respect to the source, substrate, and object is individually determined in a coordinate system whose origin lies on the surface of said object at the center of the corresponding predetermined area.

28. A reflector according to claim 26, wherein there is one object and a single predetermined area, and wherein the energy from the source that is reflected from all of the reflecting segments falls on the single predetermined area on the surface of the object.

29. A reflector according to claim 26, wherein there is one object having a plurality of said predetermined areas, and the energy from the source that is reflected from respective reflecting segments falls on different predetermined areas on the surface of the object.

30. A reflector according to claim 26, wherein the reflecting segments are oriented to direct light from two or more sources to one or more objects.

31. A reflector according to claim 26, wherein the reflecting segments are oriented to direct light from one or more sources to two or more objects.

32. A reflector according to claim 26, wherein the reflecting segments are oriented such that said at least one object can be positioned at a predetermined location between the source and said reflector, said predetermined location being one member of the group consisting of on top of the surface of said reflector, on top of and to the side of the surface of said reflector, and to the side of the surface of said reflector.

33. A reflector according to claim 26, used together with one or more additional optical elements that direct the energy from the source that is reflected from said reflector onto an object positioned beneath said reflector.

34. A reflector according to claim 26, wherein said treating of the upper planar surfaces of the facets comprises one of the following:
e. polishing said surfaces until said surfaces reflect most of the energy of the relevant wavelengths; or
f. coating said surfaces with a thin layer of material that reflects most of the energy of the relevant wavelengths.

35. A reflector according to claim 26, wherein the shape of the substrate is chosen from the following group:
(a) flat;
(b) parabolic;
(c) parabolic trough;
(d) spherical trough;
(e) dish shaped having a non-parabolic curvature;
(f) “witch's hat”; and
(g) “sombrero”.

36. The reflector of claim 26, wherein said one or more objects comprise surfaces or surface portions of given dimensions to which said radiation is to be directed, and the maximum dimensions of individual reflecting segments are no larger than the dimensions of the respective object surfaces or surface portions to which radiation is to be directed.

37. A method for designing a reflector according to claim 26, comprising activating a computerized system comprising software that is adapted to assist the user to compute and plot distances and shapes in three dimensions in order to determine the orientation of each of the upper planar surfaces of the facets with respect to the substrate from the overall parameters of the source-reflector-object system.

38. A method according to claim 37, comprising activating a computerized system to provide guidance to manufacturing machines adapted to produce reproductions of the substrate.
